(19) United States
(12) Patent Application Publication
(10) Pub. No.: US 2016/0113239 A1
(43) Pub. Date: Apr. 28, 2016

(54) PET BED

(71) Applicant: David Hagemeier, Arden Hills, MN (US)

(72) Inventor: David Hagemeier, Arden Hills, MN (US)

(21) Appl. No.: 14/887,987

(22) Filed: Oct. 20, 2015

Related U.S. Application Data
(60) Provisional application No. 62/069,580, filed on Oct. 28, 2014.

(51) Int. Cl. A01K 1/035

(52) U.S. Cl. CPC A01K 1/0353

(57) ABSTRACT

A pet bed includes a platform configured to accommodate an animal and a base connected to the platform. The base has an entrance opening to channel thermal energy from an external climate control source; such as a wall, floor, or baseboard vent or an air conditioning unit; to the platform. The pet bed includes a plurality of feet adjacent to the base to elevate the bed above a surface on which the bed is located to form at least one exit opening through which thermal energy can propagate to a room in which the pet bed is located. The pet bed can be rectangular, circular, or another shape and can have a pad that is located adjacent to the platform on which an animal may sit or lie.

### CROSS-REFERENCE TO RELATED APPLICATION

This application claims priority to U.S. Provisional Application No. 62/069,580, filed on Oct. 28, 2014, and entitled “Pet Warming Bed,” the disclosure of which is incorporated by reference in its entirety.

### BACKGROUND

The present disclosure relates to accommodations for animals and, in particular, to a warming or cooling bed for pets.

Pet beds are commonly used with domesticated animals, such as cats and dogs. These beds usually include a cushion and are placed on the floor to provide a comfortable area for pets to sit or lie. Often times, a pet can become warm or cold and may abandon the comfort of the bed and sit or lie near a climate control source, such as an air conditioner, floor vent, wall vent, or baseboard vent. While the climate control source may warm or cool the pet, the pet sitting or lying on or near the climate control source can block the flow of thermal energy into the room, cause hair or dander to be deposited in the climate control source, and cause burns or other injuries to the pet.

### SUMMARY

A pet bed is disclosed that includes a platform configured to accommodate an animal, a base connected to the platform, and a plurality of feet adjacent to the base. The base is configured to channel thermal energy from an external climate control source to the platform while also allowing thermal energy to exit the base to heat or cool a room in which the pet bed is located. Airspace within the base underneath the platform holds thermal energy (which encompasses warmer than ambient or cooler than ambient air) emitted from the external climate control source, allowing the platform to stay heated or cooled between operational cycles of the external climate control source. The plurality of feet form at least one exit opening, which is configured to allow a portion of the thermal energy to exit the pet bed and propagate into a room in which the pet bed is located.

Another embodiment of an animal resting apparatus includes a frame with legs and lateral supports connecting the legs and a cover surrounding the frame and forming a platform at a top of the frame that is configured to accommodate an animal. The cover is configured to channel thermal energy from an external climate control source to the platform while also allowing thermal energy to exit the base through an exit opening to heat or cool a room in which the animal resting apparatus is located. Airspace within the cover underneath the platform holds thermal energy (i.e., heated or cooled air) from the external climate control source, allowing the platform to stay heated or cooled between operational cycles of the external climate control source.

The present summary is provided only by way of example and not limitation. Other aspects of the present disclosure will be appreciated in view of the entirety of the present disclosure, including the entire text, claims, and accompanying figures.

### BRIEF DESCRIPTION OF THE DRAWINGS

FIG. 1A is a perspective view of a pet bed.

FIG. 1B is a perspective view of the pet bed in FIG. 1A without a pad.

FIG. 1C is an elevation view of the pet bed in FIG. 1A.

FIG. 1D is a plan view of the pet bed in FIG. 1A.

FIG. 2A is a plan view of an alternate embodiment of a pet bed.

FIG. 2B is an elevation view of the pet bed in FIG. 2A.

FIG. 3A is a perspective view of another alternate embodiment of a pet bed.

FIG. 3B is another perspective view of the pet bed in FIG. 3A without a pad.

FIG. 3C is a perspective view of the pet bed in FIG. 3A with a duct.

FIG. 4A is a perspective view of a third alternate embodiment of a pet bed.

FIG. 4B is a perspective view of the pet bed of FIG. 4A showing the underside of the pet bed.

FIG. 5A is a perspective view of a fourth embodiment of a pet bed.

FIG. 5B is a perspective view of the pet bed in FIG. 5A without a pad.

While the above-identified figures set forth embodiments of the present disclosure, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features and components not specifically shown in the drawings.

### DETAILED DESCRIPTION

A pet bed, also known as an animal resting apparatus, is disclosed that channels thermal energy, which encompasses warmer than ambient or cooler than ambient temperature air, from an external climate control source; such as a floor, wall, baseboard, or another type of vent or air conditioner; to a platform configured to allow an animal to sit or lie in warmth or coolness (depending on the atmosphere surrounding the pet bed and pet). The pet bed has an entrance opening to airspace within the base and adjacent the platform to allow thermal energy to reach the platform whether the pet bed is positioned on a floor vent or next to a wall vent, baseboard vent, or air conditioning unit. The pet bed can have feet that elevate the pet bed above the floor and create exit openings that allow thermal energy to exit the pet bed and propagate to the rest of the room. The pet bed can have a pad that is placed on the platform to provide a more comfortable surface for pets, and the pet bed can include a duct that runs from the external climate control source (which provides thermal energy) to the platform so as to allow the pet bed to be placed a distance away from the external climate control source. The pet bed can have a variety of shapes and sizes, depending on the animal to be accommodated, the size and type of external climate control source, and other considerations. The pet bed provides thermal energy to the pet while preventing the pet from blocking the climate control source, which can cause the room to become an undesirable temperature (either too hot or too cold due to the external climate control source being blocked), cause hair and dander to enter the climate control source or be blown about the room, and burn or otherwise injure the pets.

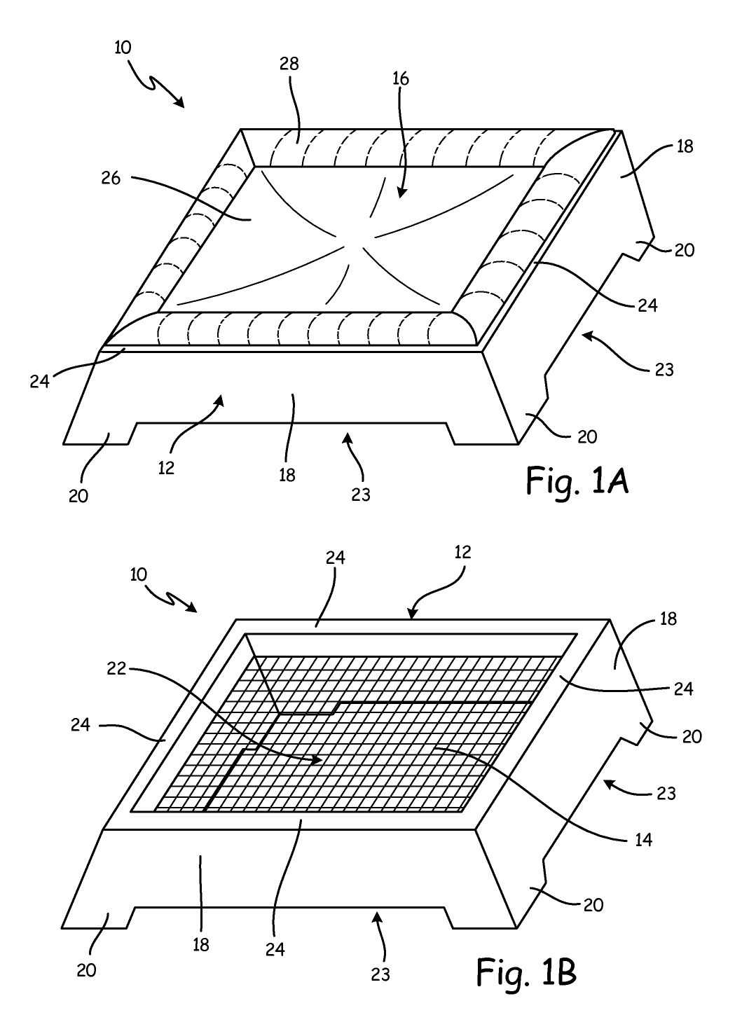

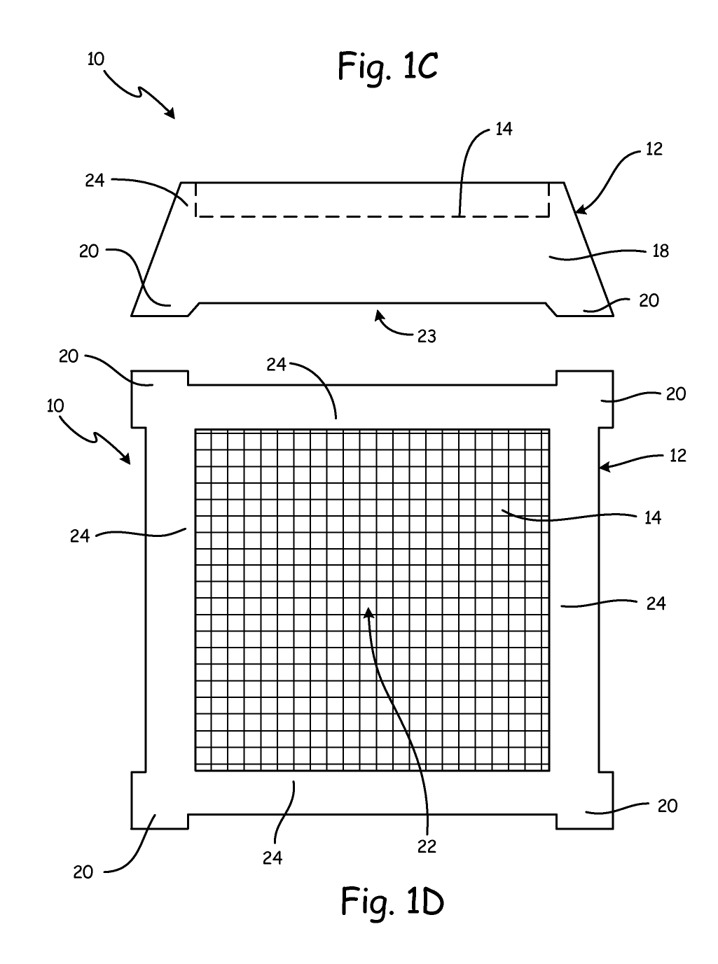

FIG. 1A is a perspective view of a pet bed, FIG. 1B is a perspective view of the pet bed in FIG. 1A without a pad, FIG. 1C is an elevation view of the pet bed in FIG. 1A, and FIG. 1D is a plan view of the pet bed in FIG. 1A. Pet bed 10 is suitable for use with a floor vent such that pet bed 10 sits on the floor over the floor vent (not shown) of the external climate control source. Pet bed 10 includes base 12, platform 14, and pad 16. Base 12 includes walls 18, feet 20, entrance opening 22 on and underside of base 12, exit openings 23 between walls 18 and a floor upon which pet bed 10 is located, feet 20, and lip 24. Pad 16 includes seat 26 and rim 28.

Base 12 is the main structural component of pet bed 10 and is configured to channel thermal energy from the external climate control source, such as a floor vent (not shown), to platform 14 and pad 16. Base 12 contains entrance opening 22, which is on an underside of base 12 and is adjacent to the floor vent, to allow thermal energy to enter airspace within base 12 and eventually warm or cool platform 14 and pad 16. Thermal energy (i.e., heated or cooled air) can exit base 12 through exit openings 23, which are openings between a bottom of walls 18 and the floor, with the openings being formed by feet 20 elevating pet bed 10. Thermal energy exits base 12 through exit openings 23 to heat or cool a room in which pet bed 10 is located. The members making up base 12 can be relatively thin or thick depending on the types of materials used to construct base 12 and the support needed. Base 12 can be one continuous and monolithic piece or can be made from a number of pieces fastened together, and base 12 can be constructed from a variety of materials, including plastic, wood, aluminum or another metal, rubber, and/or a composite material.

The main vertical members of base 12 are walls 18, which form entrance opening 22 (on an underside of base 12) and allow platform 14 to be elevated above the floor. While FIGS. 1A-1D show walls 18 forming base 12 so as to have a rectangular shape, base 12 can have any number of shapes and configurations. Walls 18 can be entirely vertical, can slant inward so that feet 20 are outward from lip 24, can slant outward so that feet 20 are inward from lip 24, can curve in a vertical and/or horizontal direction, can extend outward or inward to form a stair-step shape, or can have another configuration. Additionally, walls 18 need not meet one another at a right angle or have the same configuration as other walls 18 of base 12.

Feet 20 are at a bottom side of walls 18 and elevate base 12 and walls 18 off the floor. Feet 20 elevate walls 18 off the floor to create exit openings 23, which are openings between the bottom of walls 18 and the floor to allow thermal energy to exit pet bed 10. This is desirable to allow thermal energy to reach the rest of a room in which pet bed 10 is located to keep the room at a suitable temperature. While FIGS. 1A-1D show feet 20 at each corner of base 12, feet 20 can be located anywhere along the bottom side of walls 18. Base 12 can also be configured without feet 20 and exit openings 23 such that walls 18 extend all the way to the floor so that there is no space between the bottom of walls 18 and the floor. In this configuration, thermal energy exits base 12 through diffusion, including air leaks around pad 16 and air leaks at a bottom edge of walls 18 between walls 18 and the floor. Pet bed 10 not having feet 20 and exit openings 23 may be desirable when less thermal energy needs to be propagated to the room and/or for aesthetic preferences.

Between adjacent and opposite walls 18 at the underside of base 12 is entrance opening 22, which channels thermal energy (i.e., heated or cooled air) from an external climate control source, such as a floor vent upon which pet bed 10 is located and which is adjacent to entrance opening 22, to an airspace within base 12 and eventually to platform 14 and pad 16. Entrance opening 22 is on an opposite side of base 12 than platform 14 (with airspace therebetween) and can have an area that is larger, equal to, or smaller than the area of platform 14. While FIGS. 1A-1D show entrance opening 22 having a rectangular shape, entrance opening 22 can have a variety of shapes and configurations.

Exit openings 23 are at a bottom side of walls 18 vertically between walls 18 and the floor and horizontally between adjacent feet 20. Exit openings 23 are formed by feet 20 elevating walls 18 above the floor to form a space between the bottom of walls 18 and the floor. Exit openings 23 allow thermal energy from within base 12 (the airspace within base 12) to propagate to the room in which pet bed 10 is located. While FIGS. 1A-1D show exit openings 23 each having an elongated rectangular shape, exit openings 23 can have a variety of shapes and configurations depending on the shape and placement of feet 20.

At a top side of walls 18 is lip 24, which extends upward past platform 14 and provides side support to pad 16 to prevent pad 16 from falling off platform 14. Lip 24 can be an extension of walls 18 (so as to be one continuous and monolithic piece with walls 18) or can be a separate component. Lip 24 can have a top with a square edge (shown in FIGS. 1A-1D), a rounded edge (i.e., a fillet), a pointed edge, or a stair-step shaped edge. Additionally, lip 24 can extend inward over the top of a portion of pad 16 to more extensively hold pad 16 in place or outward to form a wider ledge for animals to utilize to climb onto and off of pad 16.

Platform 14 is secured to and located between walls 18 and provides support to pad 16 (and an animal utilizing pet bed 10). Platform 14 should allow thermal energy to flow from the airspace within base 12 to pad 16, either by being constructed from a thermally conducting material, by being constructed from a material that allows thermal energy to flow through it (such as fabric), or by being a perforated surface with a uniform or non-uniform array of orifices. In FIGS. 1A-1D, platform 14 is a mesh that allows thermal energy to easily flow to pad 16. Whether platform 14 is constructed from fabric, wire, metal, plastic, a composite material, or another material, platform 14 should be sufficiently strong to support pad 16 and the animals sitting or lying on top of pad 16. Platform 14 can be incorporated into walls 18 such that platform 14 and walls 18 are made from one continuous and monolithic piece or platform 14 can be made from a separate piece (or pieces) that is fastened to an inner side of walls 18 or lip 24. Platform 14 can be a variety of sizes, including spanning the entire distance between walls 18 (to cover the entire area between walls 18) or only spanning between opposite walls 18 to form support strips. Platform 14 can be located near the top of walls 18 such that there is no lip 24 or near the bottom of walls 18 such that lip 24 is vertically longer than walls 18.

Pad 16 is located on top of platform 14 adjacent to lip 24. Pad 16 provides a comfortable area for the animals to sit or lie. Pad 16 can include seat 26, which is the relatively flat area where the pet(s) can sit or lie, and rim 28, which surrounds 28 and can provide side support to the pet(s). Pad 16 is a cushion constructed from a variety of materials, including fabric with inner padding, a composite material, or foam. While FIG. 1A shows pad 16 covering the entire surface of platform 14 (i.e., extending all the way to lip 24), pad 16 can be smaller than the surface of platform 14 so as to not extend all the way to lip 14 or can be larger than the surface of platform 14 so as extend over the top of lip 24. Pad can be a variety of shapes and configurations and can be suited to fasten to base 12 or platform 14 to prevent pad 16 from becoming separated from pet bed 10.

As mentioned above, pet bed 10 provides a comfortable and warm or cool bed for pets to sit and lie by channeling thermal energy from the external climate control source to platform 14 and pad 16. Pet bed 10 can be positioned above a floor vent such that thermal energy flows from the floor vent, though entrance opening 22 into the airspace within base 12, and to platform 14 and pad 16. As will be discussed later, a duct can be used to channel thermal energy to pet bed 10 if it is desired that pet bed 10 be positioned at a distance from the external climate control source or if pet bed 10 cannot be positioned above the external climate control source, such as when the external climate control source is a wall or baseboard vent or air conditioning unit. Pet bed 10 can be sized and shaped to accommodate a variety of animals and multiple animals at the same time and can include the addition of other components, such as stairs.

Pet bed 10 has many advantages. Pet bed 10 does not require an internal heat or cool source; such as a heater, heat blanket, or other heating element or a fan, refrigeration device, or other cooling element; making pet bed 10 safe, simple, and easy to move and conform to any room. Pet bed 10 can be configured (through the use of feet 20 creating exit openings 23 between the floor and walls 18) so as to not completely block the propagation of thermal energy into the room, which can cause the room to become hot or cold while pet bed 10 becomes cool or warm, respectively. Pet bed 10 provides a comfortable and safe area away from the external climate control source, which reduces or eliminates pet hair or dander from being deposited into the external climate control source and reduces or eliminates pet hair or dander from being blown about the room by the external climate control source. Pet bed 10 also provides a warm or cool surface (platform 14) that is larger in area than the external climate control source, allowing multiple animals to enjoy the warmth or coolness of the external climate control source simultaneously.

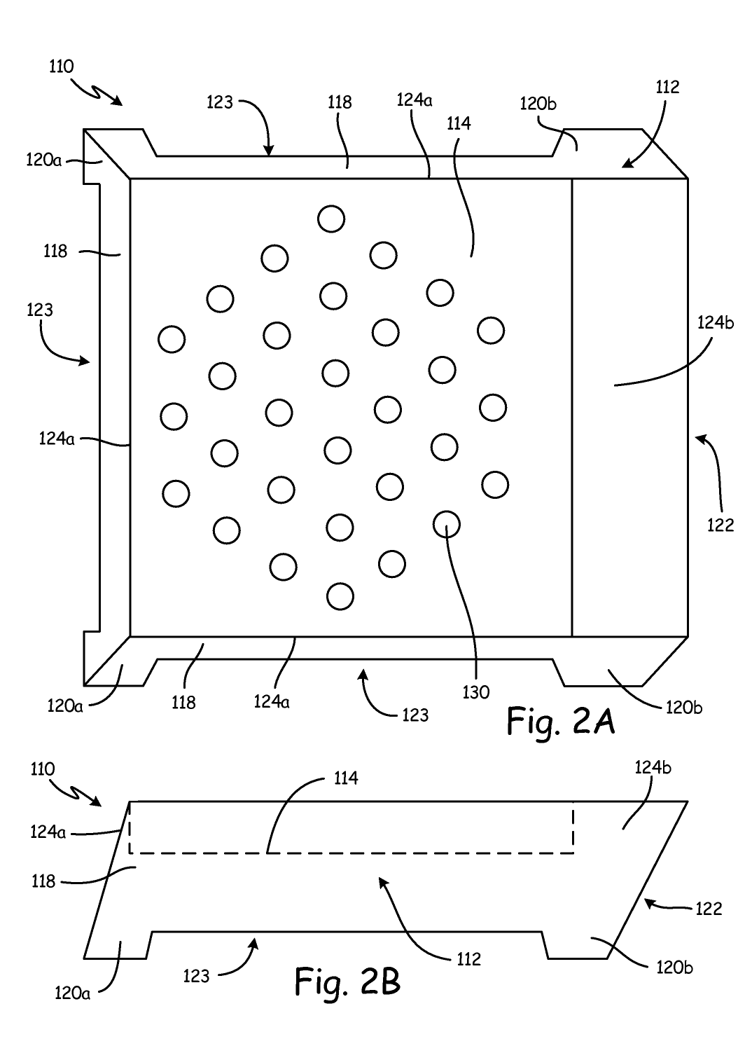

FIG. 2A is a plan view of an alternate embodiment of a pet bed (also known as an animal resting apparatus), and FIG. 2B is an elevation view of the pet bed in FIG. 2A. Pet bed 110 is suitable for use with a baseboard vent or heater (not shown), which would be located on a wall adjacent to entrance opening 122. Pet bed 110 includes base 112, platform 114, and a pad (not shown, but similar to pad 16 of pet bed 10). Base 112 includes walls 118. Walls 118 are present only on three sides of base 112 with the fourth side being entrance opening 122, which is placed adjacent to the external climate control source, such as a baseboard vent or heater. Base 112 also includes feet 120 (having narrow feet 120a and wide feet 120b), entrance opening 122, exit openings 123, and lip 124 (having narrow lip 124a and wide lip 124b). Platform 114 includes orifices 130. Pet bed 110 of FIGS. 2A and 2B is configured to be placed with entrance opening 122 (which is located below wide lip 124b) adjacent to the external climate control source, such as a baseboard vent or heater (not shown), with wide lip 124b extending over the top of the baseboard vent or heater to channel thermal energy to the airspace within base 112 and eventually to platform 114.

Base 112 has three walls 118 that are similar to walls 18 of pet bed 10, but base 112 does not have a wall on a fourth side. Rather, base 112 has entrance opening 122 on a fourth side (the side in which lip 124b is located) to channel thermal energy from the baseboard vent or heater to the airspace within base 112 and eventually to platform 114. Wide lip 124b is located above entrance opening 122 to extend over the top of the baseboard vent or heater. Entrance opening 122 can be a variety of sizes or configurations to better channel thermal energy to airspace within base 112.

At the bottom of walls 118 are feet 120, with narrow feet 120a being at a location where two walls 118 come together and wide feet 120b being at a location where one wall 118 meets entrance opening 122. Narrow lip 124a is located at a top of walls 118. As seen most easily in FIG. 2B, narrow lip 124a has a top with a pointed edge, but narrow lip 124a can have a variety of other configurations, including a square edge, a rounded edge, or a stair-step shaped edge. Wide lip 124b is shown in FIG. 2B as having a flat top, but wide lip 124b can have a variety of other configurations, including a pointed top, a rounded top, or a stair-step shaped top. The configuration of wide lip 124b can depend on the configuration of the baseboard vent or heater and/or aesthetic preferences. Base 112 can be sized and shaped to accommodate a variety of animals and multiple animals at the same time, which can include the addition of other components, such as stairs.

Similar to exit openings 23 of pet bed 10, exit openings 123 of pet bed 110 are vertically between walls 118 and a floor and horizontally between narrow feet 120a and between narrow feet 120a and wide feet 120b. Exit openings 123 are below each of the three walls 118 and allows thermal energy within base 112 to exit airspace within base 112 into a room in which pet bed 110 is located to keep the room at a suitable temperature.

Platform 114 is similar to platform 14 of pet bed 10, but platform 114 of FIGS. 2A and 2B includes orifices 130, which allow thermal energy to reach a pad placed on top of platform 114 or, if no pad is present, allow thermal energy to reach the animals. Orifices 130 can be any size, shape, or arrangement suitable for allowing thermal energy to reach the pad and/or the animals. Additionally, platform 114 can include any number of configurations that allow for the pad and/or the animals to become warm or cool (discussed with regards to pet bed 10 in FIGS. 1A-1D).

As with the other embodiments of the pet bed, pet bed 110 in FIGS. 2A and 2B can be any size, shape, or configuration to better suit the animal using pet bed 110 and/or channel thermal energy from the external climate control source to platform 114. Additionally, other configurations of pet bed 110 may be considered for aesthetic preferences.

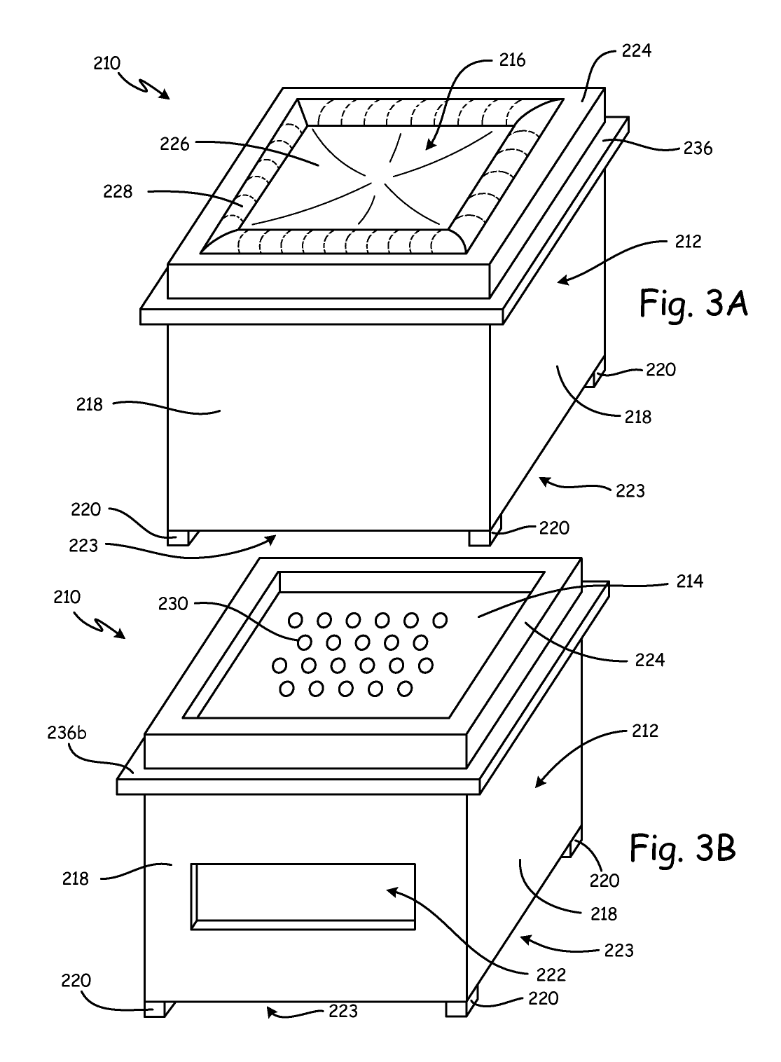

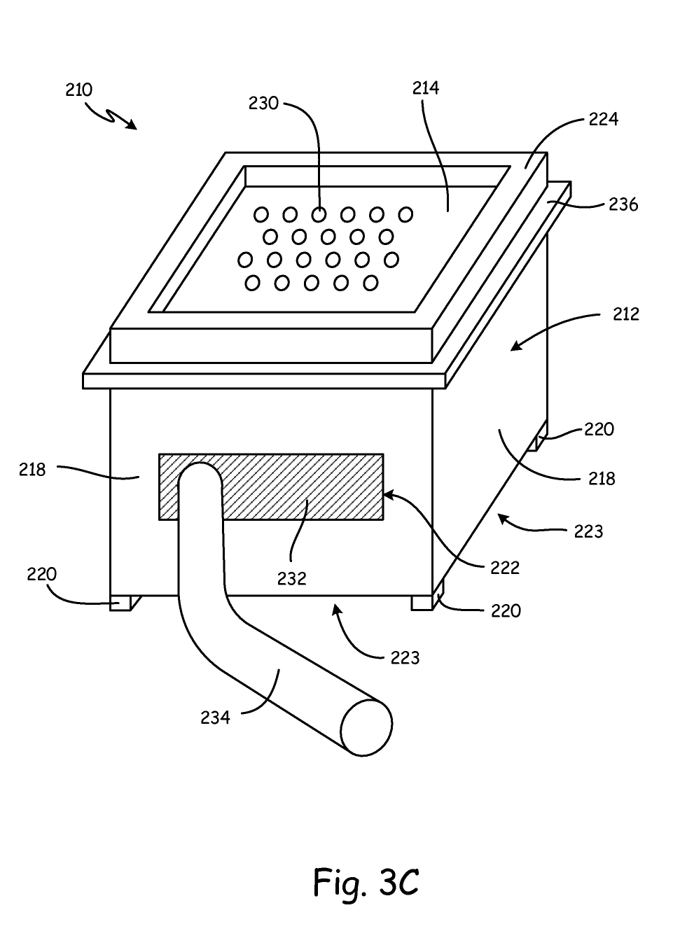

FIG. 3A is a perspective view of another alternate embodiment of a pet bed (also referred to as an animal resting apparatus), FIG. 3B is another perspective view of the pet bed in FIG. 3A without a pad, and FIG. 3C is a perspective of the pet bed in FIG. 3A with a duct. Pet bed 210 includes base 212, platform 214, and pad 216. Base 212 includes walls 218, feet 220, entrance opening 222, exit opening 223, lip 224, and ledge 236. Platform 214 includes orifices 230, while pad 216 includes seat 226 and rim 228. Pet bed 210 can also include cap 232 and duct 234, which are shown in FIG. 3C.

Pet bed 210 of FIGS. 3A-3C functions similarly to pet bed 10 of FIGS. 1A-1D but has a different overall shape and configuration with walls 218 being taller than those of pet bed 10 so as to make platform 214 higher, platform 214 including orifices 230, entrance opening 222 being within one wall 218 and able to accommodate cap 232 and duct 234, and base 212 having ledge 236.

Base 212 includes four vertical walls 218 that are taller than walls 18 of pet bed 10. Walls 218 that are taller may be desirable if a pet wishes to sit or lie on pet bed 210 while looking out an elevated window. Additionally, taller walls 218 can provide extra surface area so that entrance opening 222 is within one wall 218 to better suit use with a wall vent. As with all disclosed embodiments, walls 218 can have a variety of sizes and configurations depending on the animal intending to use pet bed 210, the external climate control source, the intended location of pet bed 210, and aesthetic preferences.

Platform 214 includes orifices 230, which are similar to orifices 130 of platform 114 in FIGS. 2A and 2B. Orifices 230 allow thermal energy to reach pad 216 or, if no pad 216 is present, allow thermal energy to reach the animals. Orifices 230 can be any size, shape, or arrangement suitable for allowing thermal energy to reach pad 216 and/or the animals. Additionally, platform 214 can include any number of configurations that allow for pad 216 and the animals to become warm or cool (discussed with regards to pet bed 10 in FIGS. 1A-1D).

Entrance opening 222 of pet bed 210 has the same function as entrance opening 122 of pet bed 110: to channel thermal energy from the external climate control source, such as a wall vent, to the airspace within base 212 and to platform 214. However, entrance opening 222 is located in one wall 218 so as to be better suited to channel thermal energy from a wall vent. As will be discussed later, entrance opening 222 can be plugged through the use of cap 232 if pet bed 210 is intended to be placed over a floor vent.

Entrance opening 222 can be modified through the use of cap 232 and duct 234, which channel thermal energy to entrance opening 222 to allow thermal energy to more efficiently reach platform 214. Cap 232 prevents thermal energy from escaping pet bed 210 through entrance opening 222, while duct 234 can channel thermal energy from an external climate control source some distance away from pet bed 210 to entrance opening 222. Duct 234 can be constructed from any material suited to adjust to an external climate control source and channel thermal energy to entrance opening 222, such as a flexible material that is adjustable in length, size, and shape. While cap 232 is shown to plug entrance opening 222 except for the area into which duct 234 extends, cap 232 can also be configured to plug the entire area of entrance opening 222 to prevent thermal energy from escaping through entrance opening 222 in one wall 218. Such a configuration may be desired when pet bed 210 is utilized with a floor vent so that thermal energy is only entering on a bottom side of pet bed 210. No cap 232 on entrance opening 222 in one wall 218 may be desired when pet bed 210 is utilized without legs 220 and with a floor vent such that thermal energy can propagate out of pet bed 210 through entrance opening 222 to a room in which pet bed 210 is located. Cap 232 can be made of a variety of materials; including plastic, rubber, wood, metal, or a composite material; but should be suited to plug entrance opening 222 to prevent the flow of thermal energy out of pet bed 210.

Ledge 236 is between walls 218 and lip 224 and extends outward away from base 212. Ledge 236 can be included in pet bed 210 for aesthetic preferences or can be necessary for construction of pet bed 210, with walls 218 being one continuous and monolithic piece, ledge 236 and platform 214 being one continuous and monolithic piece fastened to a top of walls 210, and lip 224 being fastened to the top of platform 214 and ledge 236. If preferred, pet bed 210 need not include ledge 236.

Pet bed 210 includes legs 220 on the bottom corner of each of walls 218 to elevate base 212 and walls 218 to create exit openings 223, which allow thermal energy to leave base 212 and propagate to the room to keep the room at a suitable temperature. Pet bed 210 can also be configured without legs 220 and exit opening 223 such that walls 218 are in contact with the floor. Pet bed 210 without legs 220 can function with a floor vent and without the use of cap 232 so that thermal energy can propagate through entrance opening 222 into the room, or pet bed 210 without legs 220 can function with a floor vent with the use of cap 232 if it is desirable that less thermal energy be propagated to the room and/or for aesthetic preferences. As with the other embodiments of the pet bed, pet bed 210 in FIGS. 3A-3C can be any size, shape, or configuration to better suit the animal using pet bed 210 and channel thermal energy from the external climate control source to platform 214.

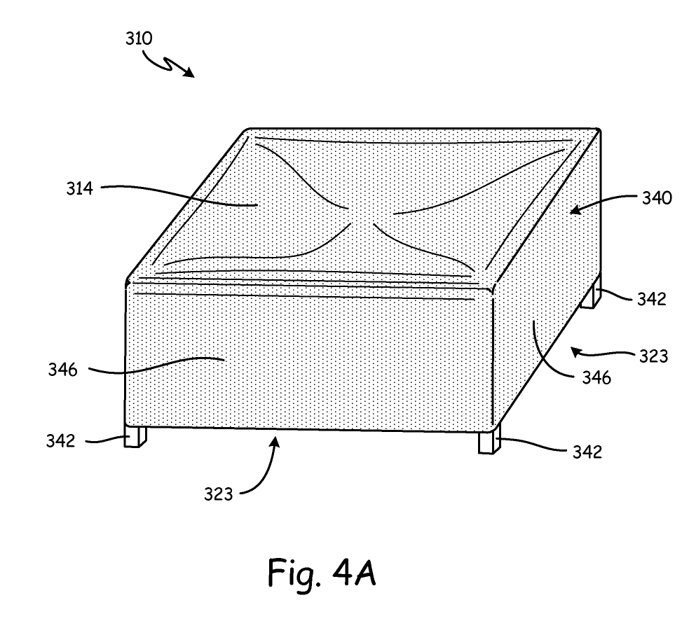

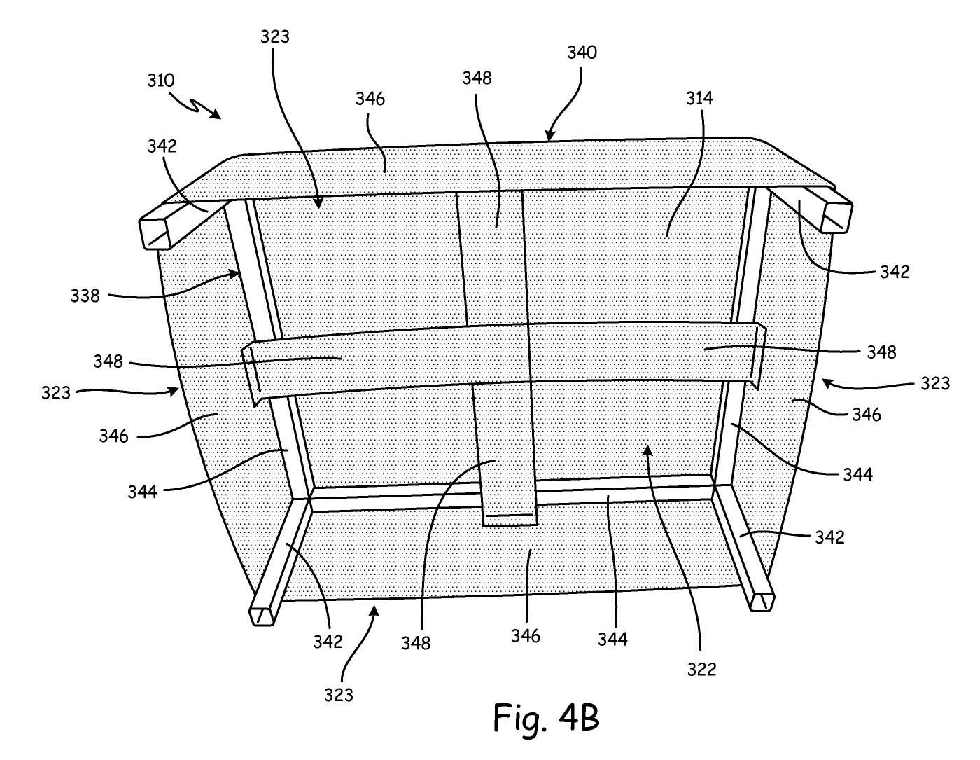

FIG. 4A is a perspective view of a third alternate embodiment of a pet bed (also referred to as an animal resting apparatus), and FIG. 4B is a perspective view of the pet bed of FIG. 4A showing the underside of the pet bed. Pet bed 310 includes frame 338 and cover 340. Frame 338 includes legs 342 and lateral supports 344. Cover 340 includes platform 314, sides 346, and straps 348. The configuration of pet bed 310 and cover 340 creates entrance opening 322 on a bottom side, while exit openings 323 are formed by cover 340 having a height that is less than a height of legs 342 to create a space between a bottom edge of sides 346 and a floor on which pet bed 310 is located. While the components and configuration of pet bed 310 of FIGS. 4A and 4B are different than pet bed 10 of FIGS. 1A-1D, the functionalities of both embodiments are similar.

For structural support, pet bed 310 includes frame 338. Frame 338 has legs 342, which extend substantially vertical, and lateral supports 344, which extend substantially horizontal between legs 342. Frame 338 can be relatively thin or thick depending on the types of materials used to construct frame 338 and the support needed. Frame 338 (legs 342 and lateral supports 344) can be one continuous and monolithic piece or can be made from a number of pieces fastened together and can be made from a variety of materials, including plastic, wood, aluminum or another metal, rubber, PVC pipe, and/or a composite material. While FIGS. 4A and 4B show frame 338 having four legs 342 with four lateral supports 344 extending between adjacent legs 342, frame 338 can have a variety of configurations, including a different number of legs 342 in a different arrangement or orientation, a different number of lateral supports 344 in a different arrangement or orientation, and a different shaped and/or sized frame 338.

Cover 340 has platform 314 as a top; sides 346, which are situated similarly to walls 18 of pet bed 10; and straps 348, which hold cover 340 in place around frame 338. Cover 340, with platform 314 and sides 346, forms entrance opening 322 on a bottom side of pet bed 310 (because cover 340 only covers the four sides 346 and the top/platform 314). With cover 340 having a height that is less than a height of legs 342, exit openings 323 are formed as a space between a bottom edge of sides 346 and the floor to allow thermal energy to propagate to the room from airspace within pet bed 310 (the airspace within cover 340). Pet bed 310 can be placed on top of a floor vent such that thermal energy from an external climate control source enters pet bed 310 through entrance opening 322 on the bottom side of pet bed 310 and is channeled to platform 314 to warm or cool a pet. Cover 340 can extend the entire height of legs 342 so that exit openings 323 are not present in pet bed 310 (no portion of legs 342 is visible when cover 340 is in place and pet bed 310 is on the floor). When pet bed has a configuration in which exit openings 323 are not present, thermal energy exits the airspace within pet bed 310 through diffusion, including air leaks through cover 340 and air leaks at the bottom edge of sides 346. Pet bed 310 without exit openings 323 may be desirable when less thermal energy needs to be propagated to the room and/or for aesthetic preferences.

Cover 340 can be one continuous and monolithic piece or can be made from a number of pieces fastened together, and can be made from a variety of materials, including fabric, plastic, and/or a composite material. The materials should be suited to allow thermal energy to flow through platform 314 to reach a pad that may be present on the top of platform 314 and/or the animals sitting or lying on the pad or platform 314. It may be desirable for cover 340 to be made from a flexible fabric that is removable from frame 338 so that cover 340 can be cleaned and/or replaced.

Straps 348 are on an underside of cover 340 and can connect to sides 346 at one end and each other or an underside of platform 314 at another end to hold cover 340 in place around frame 338 and/or to provide additional support to platform 314 and the animals sitting or lying on top of platform 314. Straps 348 can be made from the same material as the rest of cover 340 or from a different material, and can be fastened to cover 340 by a variety of means, including hook and loop fasteners (Velcro®), adhesive, or sewing. Straps 348 can attach to one another or the underside of platform 314 by a variety of means, but it may be desirable that the means is a fastener that is easily detachable, such as hook and loop fasteners. While FIG. 4B shows four straps 348 spanning only a portion of a distance across cover 340, other embodiments can include no straps 348 or any number of straps 348 that span the entire distance across cover 340, angle so as to be fastened to adjacent sides 346, or another arrangement or orientation suited to hold cover 340 in place and/or provide additional support to platform 314 and the animals sitting or lying on top of platform 314.

As with the other embodiments of the pet bed, pet bed 310 in FIGS. 4A and 4B can be any size, shape, or configuration to better suit the animal using pet bed 310 and/or channel thermal energy from the external climate control source, such as a floor vent, to platform 314.

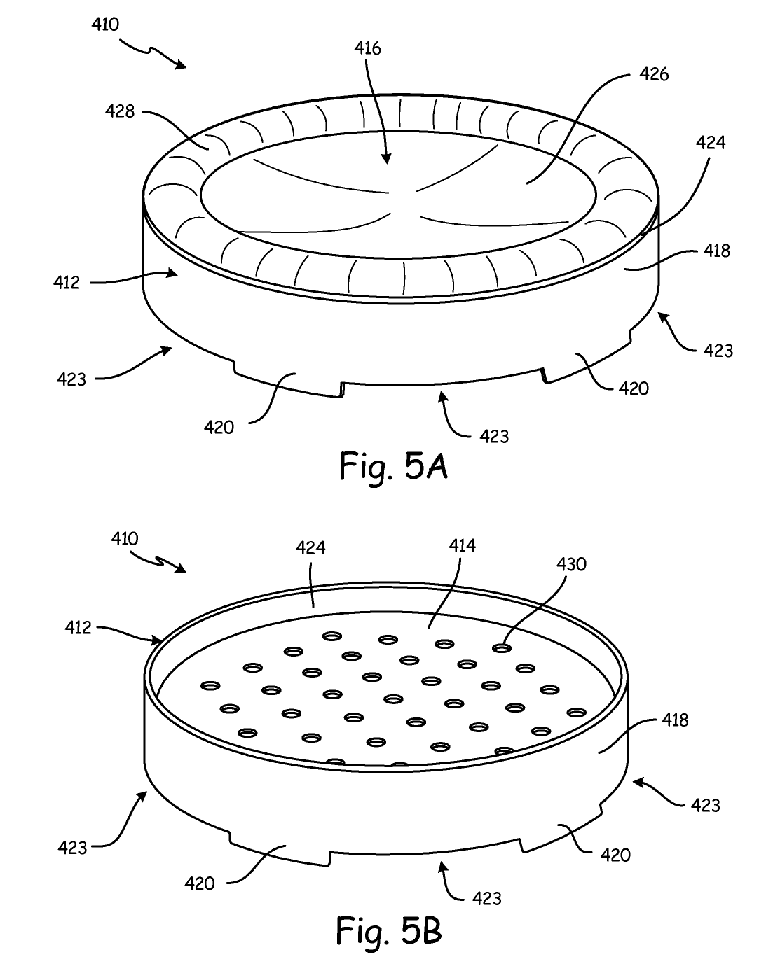

FIG. 5A is a perspective view of a fourth embodiment of a pet bed (also referred to as an animal resting apparatus), and FIG. 5B is a perspective view of the pet bed in FIG. 5A without a pad. Pet bed 410 includes base 412, platform 414, and pad 416. Base 412 includes wall 418, feet 420, an entrance opening (not viewable but similar to entrance opening 22 in FIGS. 1A-1D) on a bottom side of base 412, exit openings 423 between wall 418 and a floor on which pet bed 410 is located, and lip 424. Pad 416 includes seat 426 and rim 428. Platform 414 includes orifices 430.

Pet bed 410 of FIGS. 5A and 5B functions similarly to pet bed 10 of FIGS. 1A-1D but has a different overall shape and platform 414 includes orifices 430. Pet bed 410 can be placed over an external climate control source, such as a floor vent, with thermal energy being channeled from the floor vent, through the entrance opening on the bottom side of base 412, into airspace within base 412, and eventually to platform 414 through orifices 430. Thermal energy can propagate into a room in which pet bed 410 is located through exit openings 423, which are spaces between a bottom of wall 418 and the floor created by feet 420 elevating wall 418. Pet bed 410 is circular-shaped, with base 412 having wall 418 that is annular with feet 420 at a bottom side of wall 418 spaced along wall 418. As with other embodiments, pet bed 410 can be configured without feet 420 and exit opening 423, or feet 420 can have a variety of sizes and configurations. Base 412 and platform 414 can be one continuous and monolithic piece or a number of pieces fastened together, and can be constructed from a variety of materials. Pet bed 410 can be configured to function with any external climate control source, including a floor, wall, or baseboard vent or an air conditioning unit.

As with the other embodiments of the pet bed, pet bed 410 in FIGS. 5A and 5B can be any size, shape, or configuration to better suit the animal using pet bed 410 and/or channel thermal energy from the external climate control source to platform 414. Other configurations of pet bed 410 may be considered for aesthetic preferences.

As mentioned above, the disclosed embodiments of the pet bed have many advantages. The pet bed does not require an internal heat or cool source; such as a heater, heat blanket, or other heating element or a fan, refrigeration device, or other cooling element. Thus, the pet bed uses no additional energy other than that already provided to the home by the external climate control source. The pet bed is safe, simple, and easy to move and conform to any room (i.e., the pet bed uses the existing warm or cool source in the room). The pet bed is configured (through the use of the feet creating a space between the pet bed's walls and the floor on which the pet bed is located) so as to not block the propagation of thermal energy into the room, which can cause the room to become too cold or warm for the occupants. The pet bed includes airspace within the base under the platform to hold thermal energy between operational cycles of the external climate control source, keeping the platform cooler or warmer than ambient room temperature between heating or cooling cycles. The pet bed provides a comfortable and safe area away from the external climate control source, which reduces or eliminates pet hair or dander from being deposited into the external climate control source and being blown about the room by the external climate control source. The pet bed also provides a warm or cool surface (the platform) that is larger in area than the external climate control source, allowing multiple pets to enjoy the warmth or coolness of the external climate control source simultaneously.

Any relative terms or terms of degree used herein, such as “substantially,” “essentially,” “generally,” “approximately,” and the like should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations; incidental alignment variations; alignment or shape variations induced by thermal, rotational, or vibrational operational conditions; and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A pet bed comprising:
a platform configured to accommodate an animal;
a base connected to the platform, the base having an entrance opening configured to channel thermal energy from an external climate control source to the platform; and
a plurality of feet adjacent to the base and forming at least one exit opening, the at least one exit opening configured to allow a portion of the thermal energy to exit the pet bed.

2. The pet bed of claim 1, wherein the at least one exit opening is a space between the base and a surface on which the pet bed is located created by the plurality of feet elevating the base above the surface.

3. The pet bed of claim 1, wherein the platform is rectangular in shape and the base includes four walls extending away from the platform.

4. The pet bed of claim 1, wherein the platform is circular in shape and the base is cylindrical in shape and extends away from the platform.

5. The pet bed of claim 1, wherein the platform includes a plurality of orifices.

6. The pet bed of claim 1, wherein the platform is constructed from a thermal conducting material.

7. The pet bed of claim 1, wherein the platform is mesh.

8. The pet bed of claim 1, wherein the entrance opening in the base is on a bottom side of the base and is configured to channel thermal energy from the external climate control source to the platform.

9. The pet bed of claim 1, wherein the entrance opening in the base is on a side of the base and is configured to channel thermal energy from the external climate control source to the platform.

10. The pet bed of claim 1, further comprising:
a pad adjacent to the platform.

11. The pet bed of claim 1, further comprising:
a duct that is configured to run from the external climate control source to the entrance opening in the base.

12. The pet bed of claim 1, wherein the base extends past the platform to form a lip surrounding the platform.

13. An animal resting apparatus comprising:
a frame with legs and lateral supports connecting the legs;
a cover surrounding the frame and forming a platform at a top of the frame that is configured to accommodate an animal, the cover having an entrance opening configured to channel thermal energy from an external climate control source to the platform.

14. The animal resting apparatus of claim 13, wherein the cover surrounds only the top and sides of the frame so that the entrance opening is at a bottom of the frame.

15. The animal resting apparatus of claim 13, further comprising:
a cushion on top of the platform.

16. The animal resting apparatus of claim 13, further comprising:
a strap connected to the cover to secure the cover to the frame.

17. The animal resting apparatus of claim 13, wherein the frame is circular and the cover is cylindrical.

18. The animal resting apparatus of claim 13, wherein the frame is rectangular with four legs at each corner and four lateral supports connecting the legs.

19. The animal resting apparatus of claim 18, wherein the length of the cover is less than the length of the legs to create an exit opening between the cover and a surface on which the animal resting apparatus is located to allow a portion of the thermal energy to exit the animal resting apparatus.

20. The animal resting apparatus of claim 13, wherein the cover is fabric.
